(19) United States
(12) Patent Application Publication
(10) Pub. No.: US 2015/0274005 A1
(43) Pub. Date: Oct. 1, 2015

(54) FUEL TANK STRUCTURE

(71) Applicants: Chiaki KATAOKA, (US); Masaki AKAGI, (US)

(72) Inventors: Chiaki Kataoka, Nagakute-shi (JP); Masaki Akagi, Okazaki-shi (JP)

(73) Assignee: TOYOTA JIDOSHA KABUSHIKI KAISHA, Toyota-shi, Aichi-ken (JP)

(21) Appl. No.: 14/434,220

(22) PCT Filed: Nov. 19, 2013
(86) PCT No.: PCT/IB2013/002586

§ 371 Date: Apr. 8, 2015

(30) Foreign Application Priority Data
Nov. 20, 2012 (JP) 2012-254281

(51) Int. Cl. B60K 15/03; B60K 15/073

(52) U.S. Cl. CPC B60K 15/03; B60K 15/073; B60K 2015/03217; B60K 2015/03243

(57) ABSTRACT

The fuel tank structure includes: a fuel tank that is configured to contain fuel inside; a liquid level detection sensor arranged in a vertical orientation inside the fuel tank and configured such that a capacitance of the liquid level detection sensor varies on the basis of a contact range in which the fuel is in contact with the liquid level detection sensor; a tubular element extending vertically while laterally surrounding the liquid level detection sensor and configured to allow the fuel to enter from a lower portion of the tubular element to an inside of the tubular element and to exit from the inside to the lower portion; and a fuel storage member that communicates with the inside of the tubular element and the inside of the fuel tank through a fuel input/output port and configured to store the fuel inside the fuel tank.

### BACKGROUND OF THE INVENTION

1. Field of the Invention

The invention relates to a fuel tank structure.

2. Description of Related Art

A fuel tank for an automobile is desired to accurately detect the liquid level of fuel contained. For example, Japanese Patent Application Publication No. 2-087022 (JP 2-087022 A) describes a liquid level measuring device that includes first to third tubular elements extending through the top and bottom of a sub-tank and that forms a measuring electrode portion and a reference electrode portion from these tubular elements. In the liquid level measuring device, the reference electrode portion is filled with fuel in the sub-tank, and a liquid level is detected by the measuring electrode portion that communicates with a main tank.

Incidentally, a fuel having a different capacitance property (for example, a fuel having a different mixture ratio of gasoline and ethanol) may be fed into a fuel tank. In a structure for detecting a liquid level on the basis of the capacitance of a capacitance sensor, when such a fuel having a different capacitance property contacts the capacitance sensor, it may be difficult to accurately detect the liquid level.

### SUMMARY OF THE INVENTION

The invention provides a fuel tank structure that is able to reduce an error of liquid level detection even when a fuel having a different capacitance property is fed.

An aspect of the invention provides a fuel tank structure. The fuel tank structure includes: a fuel tank that is configured to contain fuel inside; a liquid level detection sensor arranged in a vertical orientation inside the fuel tank and configured such that a capacitance of the liquid level detection sensor varies on the basis of a contact range in which the fuel is in contact with the liquid level detection sensor; a tubular element extending vertically while laterally surrounding the liquid level detection sensor and configured to allow the fuel to enter from a lower portion of the tubular element to an inside of the tubular element and to exit from the inside to the lower portion; and a fuel storage member that communicates with the inside of the tubular element and the inside of the fuel tank through a fuel input/output port and configured to store the fuel inside the fuel tank.

With this fuel tank structure, it is possible to detect the liquid level of the fuel inside the fuel tank from the capacitance of the liquid level detection sensor.

The liquid level detection sensor is laterally surrounded by the tubular element in the vertical direction; however, the fuel is allowed to enter from the lower portion of the tubular element to the inside of the tubular element or to exit from the inside to the lower portion. Furthermore, the fuel tank structure includes the fuel storage member that communicates with the inside of the tubular element and the inside of the fuel tank, and the fuel inside the fuel tank is stored in the fuel storage member.

In the case where the fuel tank is refueled, when the fed fuel flows into the fuel storage member, the fuel stored in the fuel storage member (the fuel inside the fuel tank before being fed) moves into the tubular element. Even when a fuel (hereinafter, referred to as “different-type fuel”) having a property different from that of the fuel remaining in the fuel tank is fed, rapid introduction of the fuel having a different property into the tubular element is suppressed. Therefore, it is possible to reduce an error of the liquid level detected by the liquid level detection sensor.

In the above aspect, a fuel storage volume of the fuel storage member may be larger than an internal volume of a portion of the inside of the tubular element, in which the liquid level detection sensor is present.

In this way, the fuel storage volume of the fuel storage member is larger than the internal volume of the portion of the inside of the tubular element, in which the liquid level detection sensor is present. Thus, even when a different-type fuel is fed, it is possible to suppress contact of the different-type fuel with the liquid level detection sensor as a whole.

In the above aspect, the fuel tank structure may further include a property detection sensor arranged inside the fuel tank and configured such that a capacitance of the property detection sensor varies on the basis of a property of the fuel.

In the property detection sensor, the capacitance varies on the basis of the property of the fuel, so it is possible to correct the liquid level detected by the liquid level detection sensor on the basis of the detected capacitance, so further accurate liquid level detection is possible.

In the above aspect, the fuel tank structure may further include a sub-cup provided inside the fuel tank and configured to contain the fuel inside the fuel tank, the property detection sensor being provided inside the sub-cup.

The fuel is contained and the property detection sensor is provided inside the sub-cup, so, in comparison with a configuration without such a sub-cup, it is possible to further reliably keep a state where the fuel inside the sub-cup is in contact with the property detection sensor even in a state where a fuel liquid surface is inclined.

A fuel pump for feeding the fuel to the outside may be provided inside the sub-cup. In this case, it is possible to reliably draw the fuel inside the sub-cup with the use of the fuel pump. In addition, in comparison with a structure that the property detection sensor is provided outside the sub-cup, it is possible to acquire the property of the fuel at a location close to the fuel pump.

In the above aspect, the fuel tank structure may further include a fuel introduction device configured to introduce the fuel inside the sub-cup into the tubular element.

After the fuel tank is refueled, by introducing the fuel inside the sub-cup into the tubular element with the use of the fuel introduction device, it is possible to bring the fuel inside the tubular element close to a uniform state, so further accurate liquid level detection is possible.

In the above aspect, the fuel introduction device may include a communication portion that communicates an upper portion of the sub-cup with an upper portion of the tubular element and a pressure pump configured to feed the fuel inside the fuel tank into the sub-cup under pressure.

The upper portion of the sub-cup and the upper portion of the tubular element communicate with each other via the communication portion. Therefore, when the fuel inside the fuel tank is fed into the sub-cup under pressure by the pressure pump, the entire or part of the fuel overflowed from the sub-cup flows into the tubular element through the communication portion. With a simple structure that the communication portion and the pressure pump are provided, it is possible to introduce the fuel inside the sub-cup into the tubular element.

In the above aspect, the fuel storage member may extend along a periphery of the sub-cup.

The fuel storage member does not excessively project outward of the sub-cup, so mounting the sub-cup on the fuel tank becomes easy.

With the above configuration according to the aspect of the invention, even when a fuel having a different capacitance characteristic is fed, it is possible to reduce an error of liquid level detection.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a front view that shows a fuel tank structure according to a first embodiment of the invention together with an engine and a fuel supply tube;

FIG. 2 is a schematic perspective view that shows a fuel pump module that constitutes the fuel tank structure according to the first embodiment of the invention;

FIG. 3 is a cross-sectional view taken along the line in FIG. 2, showing the fuel pump module that constitutes the fuel tank structure according to the first embodiment of the invention together with part of the fuel tank;

FIG. 4 is a cross-sectional view taken along the line IV-IV in FIG. 2, showing the fuel pump module that constitutes the fuel tank structure according to the first embodiment of the invention;

FIG. 5 is a front view that partially shows a capacitance sensor unit that is used in the fuel tank structure according to the first embodiment of the invention;

FIG. 6 is a cross-sectional view taken along the same line as FIG. 3, showing a state before refueling in the fuel tank structure according to the first embodiment of the invention;

FIG. 7 is a cross-sectional view taken along the same line as FIG. 3, showing a state immediately after refueling in the fuel tank structure according to the first embodiment of the invention;

FIG. 8 is a cross-sectional structure that shows a fuel pump module that constitutes a fuel tank structure according to a comparative embodiment together with part of a fuel tank;

FIG. 9 is a graph that shows a capacitance of a liquid level detection sensor after refueling the fuel tank and a capacitance ratio between the liquid level detection sensor and a property detection sensor in the case of each of the first embodiment of the invention and the comparative embodiment.

FIG. 10 is a cross-sectional view taken along the same line as FIG. 3, showing a state after a lapse of a predetermined period of time from refueling in the fuel tank structure according to the first embodiment of the invention;

FIG. 11 is a cross-sectional view taken along the same line as FIG. 4, showing a state after a lapse of a predetermined period of time from refueling in the fuel tank structure according to the first embodiment of the invention.

FIG. 12 is a cross-sectional view taken along the same line as FIG. 3, showing a state before refueling in the fuel tank structure according to the first embodiment of the invention;

FIG. 13 is a cross-sectional view taken along the same line as FIG. 3, showing a state immediately after refueling in the fuel tank structure according to the first embodiment of the invention;

FIG. 14 is a cross-sectional view taken along the same line as FIG. 3, showing a state after a lapse of a predetermined period of time from refueling in the fuel tank structure according to the first embodiment of the invention; and

FIG. 15 is a front view that partially shows a capacitance sensor unit that is used in a fuel tank structure according to a second embodiment of the invention.

### DETAILED DESCRIPTION OF EMBODIMENTS

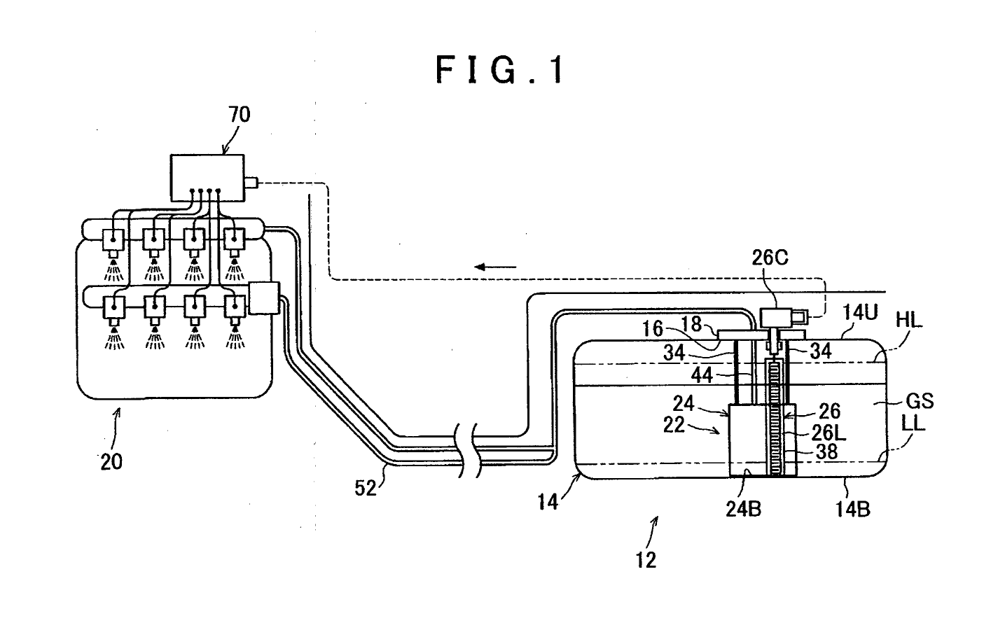

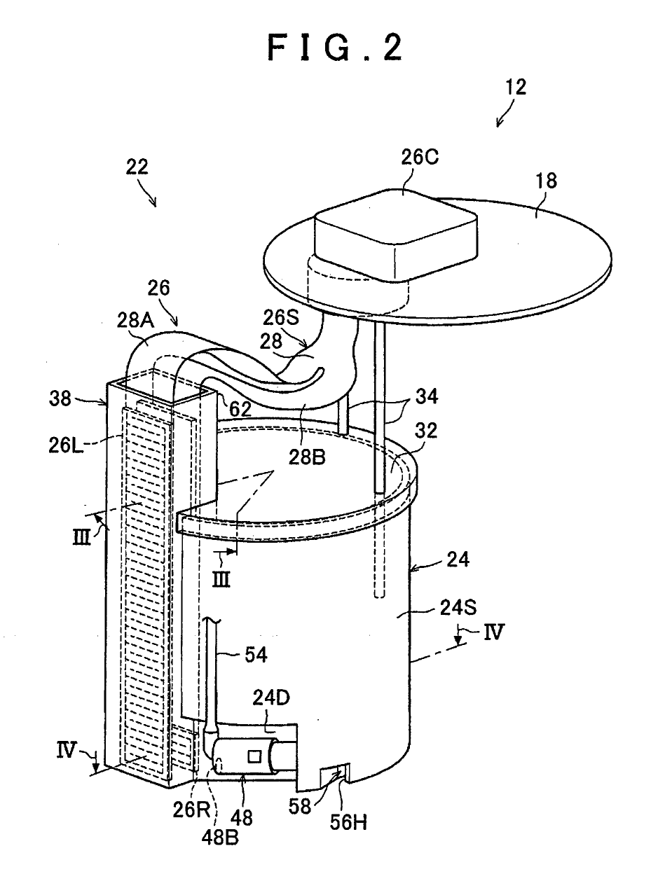

FIG. 1 shows a fuel tank structure 12 according to a first embodiment of the invention together with a fuel supply tube 52 for supplying fuel to an engine 20. FIG. 2 is a perspective view that shows a fuel pump module 22 (a sub-cup 24 and its surroundings) used in the fuel tank structure 12.

The fuel tank structure 12 includes a fuel tank 14 that is able to contain fuel inside. The fuel tank 14 has a substantially rectangular parallelepiped shape as a whole. Particularly, in the present embodiment, the volume of the fuel tank 14 is configured to be variable as a bottom wall 14B and an upper wall 14U approach or move away from each other.

A full-tank, level HL and an alarm level LL are set for the fuel tank 14. The full-tank level HL is a liquid level that is set such that, as the liquid level reaches the full-tank level HL when fuel is fed into the fuel tank 14, fuel cannot be fed any more. Thus, normally, the liquid level in the fuel tank 14 does not exceed the full-tank level HL. In addition, the alarm level LL is a liquid level that is set such that, when fuel inside the fuel tank 14 is consumed, an alarm, or the like, is issued and refueling is prompted by the time when the liquid level reaches the alarm level LL.

The upper wall 14U of the fuel tank 14 has an insertion port 16. The fuel pump module 22 is allowed to be inserted through the insertion port 16. The insertion port 16 is closed by a lid member 18 from the outer side of the fuel tank 14.

The fuel pump module 22 arranged inside the fuel tank 14 is able to feed fuel inside the fuel tank 14 to the engine 20. As shown in FIG. 2 in detail, the fuel pump module 22 has the substantially cylindrical sub-cup 24 of which the upper face is open. The upper face of the sub-cup 24 is covered with a sub-cup lid 32.

One or a plurality of (two in the present embodiment) guide rods 34 extend downward from the lid member 18, and are inserted in guide cylinders of the sub-cup 24. Thus, even when the bottom wall 14B and the upper wall 14U approach or move away from each other, the position and orientation of the sub-cup 24 are kept stably. Particularly, compression coil springs are respectively mounted on the guide rods 34, and urge the guide cylinders downward with respect to the lid member 18. With this urging force, it is possible to keep a state where a bottom wall 24B of the sub-cup 24 contacts the bottom wall 14B of the fuel tank 14.

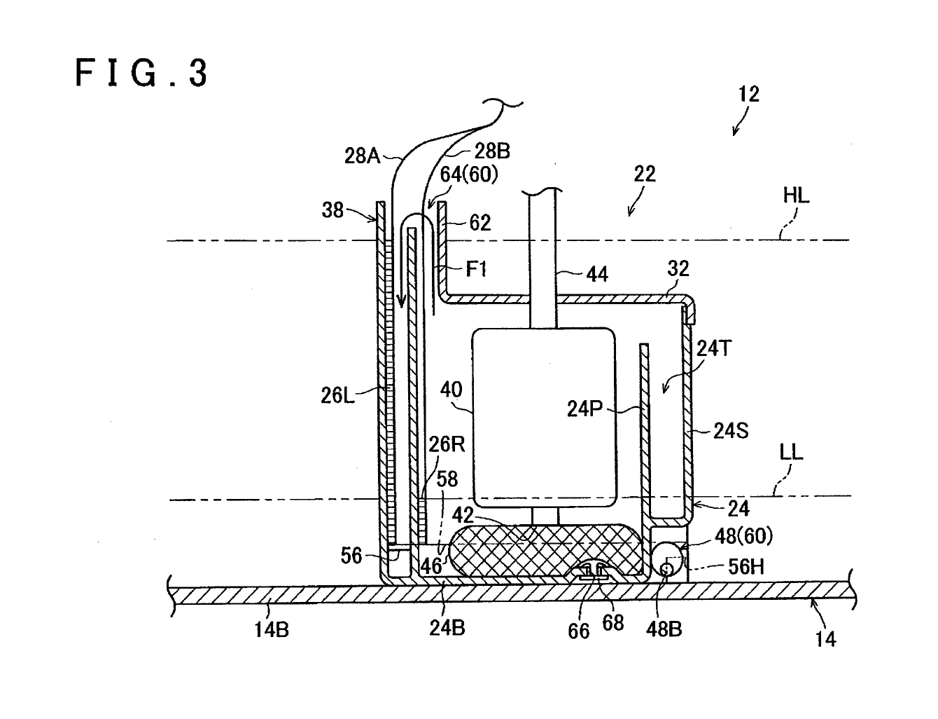

As shown in FIG. 3, a fuel pump 40 is provided inside the sub-cup 24. A fuel suction port 42 is provided below the fuel pump 40. Fuel is allowed to be drawn through the fuel suction port 42. By driving the fuel pump 40, fuel inside the sub-cup 24 is drawn through the fuel suction port 42. Fuel inside the sub-cup 24 is allowed to be fed toward the engine 20 (see FIG. 1) through a fuel feed tube 44.

A fuel filter 46 is attached to the fuel suction port 42 of the fuel pump 40. The fuel filter 46 is formed in a bag shape from a mesh member, and the fuel suction port 42 is located inside the fuel filter 46. The fuel filter 46 has the function of removing foreign matter in fuel at the time when fuel GS inside the sub-cup 24 is drawn through the fuel suction port 42.

Part of fuel inside the fuel tank 14 is stored in the sub-cup 24. Thus, even when the fuel GS is inclined and unevenly distributed with respect to the fuel tank 14, it is possible to inhibit a phenomenon (so-called shortage of fuel) that part of fuel stored in the sub-cup 24 separates from the fuel filter 46.

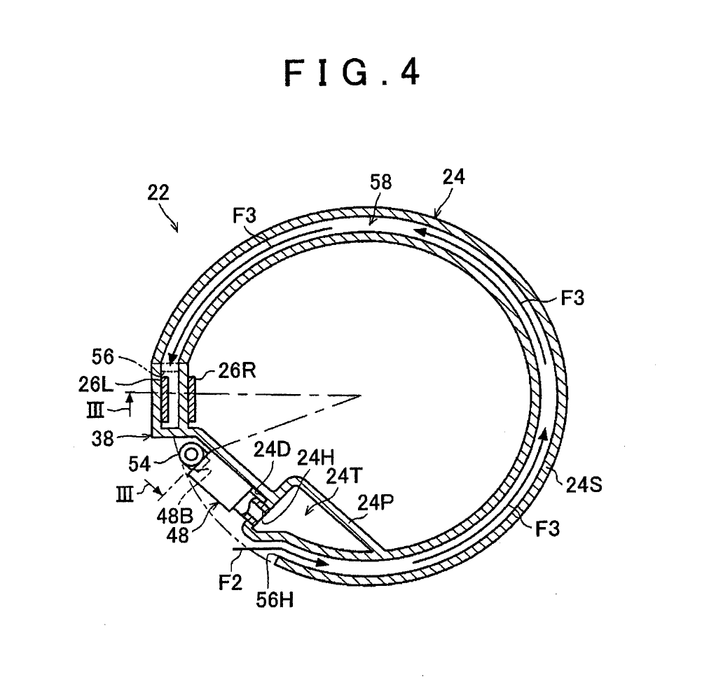

As is apparent from FIG. 2 and FIG. 4, a recess 24D formed by partially curving a peripheral wall 24S inward is formed at the lower portion of the peripheral wall 24S of the sub-cup 24. A jet pump 48 is arranged in the recess 24D.

An introduction tube 54 is connected to the jet pump 48. Part of fuel drawn by the fuel pump 40 is introduced into the jet pump 48 via the introduction tube 54 as return fuel without being delivered to the outside. A negative pressure is generated inside the jet pump 48 due to return fuel introduced from the introduction tube 54. The jet pump 48 has the function of drawing fuel GS from the outside of the sub-cup 24 (inside of the fuel tank 14) through a suction port 48B because of the negative pressure and feeding (feeding under pressure) fuel into the sub-cup 24 through a through-hole 24H formed at the recess 24D.

As shown in FIG. 3 and FIG. 4, a partition wall 24P is provided upright from the bottom wall 24B inside the sub-cup 24. The partition wall 24P surrounds the through-hole 24H together with part of the peripheral wall 24S, and is formed so as to be lower than the height of the peripheral wall 24S. A temporary containing portion 24T is formed between part of the peripheral wall 24S and the partition wall 24P. Fuel introduced from the jet pump 48 via the through-hole 24H is temporarily contained in the temporary containing portion 24T. Fuel overflowed from the temporary containing portion 24T flows beyond the partition wall 24P and is contained in the sub-cup 24 (region other than the temporary containing portion 24T). Hereinafter, a simple phrase “inside the sub-cup 24” or “the inside of the sub-cup 24” means a region other than the temporary containing portion 24T in the sub-cup 24.

FIG. 3 is a cross-sectional view taken along the line in FIG. 2. The line is also shown in FIG. 4, and indicates a cross-sectional position.

As shown in FIG. 2 and FIG. 3, the fuel pump module 22 includes a tubular element 38 located on the outer side of the sub-cup 24. The tubular element 38 is formed so as to extend to a position higher than the full-tank level HL of the fuel tank 14. In the present embodiment, as is apparent from FIG. 4, the tubular element 38 has a substantially rectangular shape in horizontal cross section, and is present at part of the outer periphery of the sub-cup 24 in plan view. Part of the tubular element 38 is shared with the peripheral wall 24S of the sub-cup 24.

A fuel input/output port 56 is formed at the lower portion of the tubular element 38 (near the bottom wall 14B). Furthermore, a fuel storage member 58 that communicates with the inside of the tubular element 38 through the fuel input/output port 56 is provided inside the fuel tank 14. Particularly, in the present embodiment, as is apparent from FIG. 4, the fuel storage member 58 is formed in a substantially annular shape extending along the peripheral wall 24S of the sub-cup 24, and an end portion at the opposite side with respect to the fuel input/output port 56 serves as an opening 56H that opens at the lower portion (near the bottom wall 14B) inside the fuel tank 14. Thus, the fuel storage member 58 communicates with both the inside of the tubular element 38 and the inside of the fuel tank 14.

The volume of the fuel storage member 58, that is, the amount of fuel (fuel storage volume) storable in a region from the opening 56H to the fuel input/output port 56, is larger than or equal to the volume of a portion of the tubular element 38, in which a liquid level detection sensor 26L (described later) is present.

Fuel inside the fuel tank 14 enters into or exits from the inside of the tubular element 38 via the fuel storage member 58 and the fuel input/output port 56. Therefore, the liquid level in the fuel tank 14 is substantially equal to the liquid level in the tubular element 38.

The upper face of the sub-cup 24 is closed by the sub-cup lid 32; however, a portion of the upper face near the tubular element 38 is open, and a fuel introduction wall 62 facing the tubular element 38 extends upward so as to surround the open portion. The fuel introduction wall 62 and the tubular element 38 form a fuel introduction passage 64 therebetween. When the jet pump 48 is driven, part of fuel overflowed from the inside of the sub-cup 24 (however, outflow of fuel into the fuel tank 14 is suppressed by the sub-cup lid 32) passes through the fuel introduction passage 64 and flows into the tubular element 38 from above as indicated by the arrow F1. A fuel introduction device 60 according to the invention includes the fuel introduction passage 64 and the jet pump 48.

Furthermore, the fuel pump module 22 includes a capacitance sensor unit 26. As shown in FIG. 2 in detail, the capacitance sensor unit 26 includes a sensor circuit unit 26C mounted on the upper face of the sub-cup lid 32 and a sensor element unit 26S extending downward from the sensor circuit unit 26C through the sub-cup lid 32.

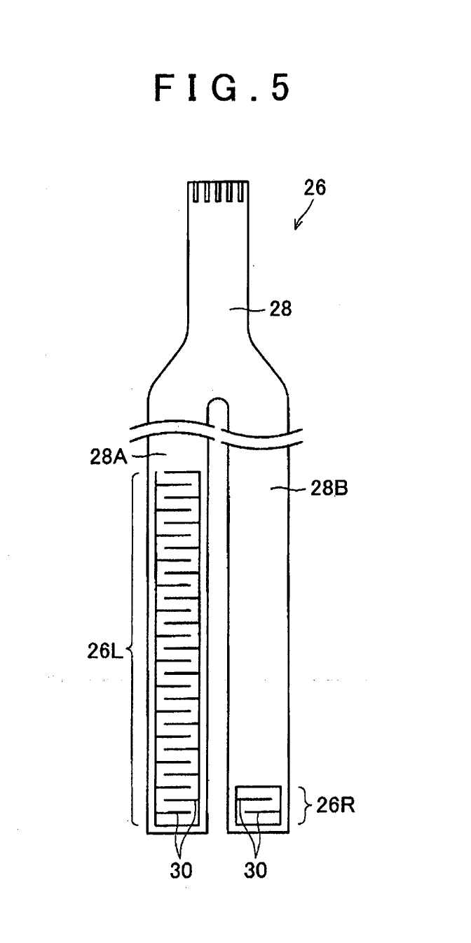

As shown in FIG. 5, the sensor element unit 26S has a base 28 that is formed in a substantially long shape as a whole from a foldable insulator, such as a resin film. The distal end of the base 28 is branched off in a bifurcated shape, and has a first base portion 28A and a second base portion 28B.

As shown in FIG. 2 and FIG. 3, the first base portion 28A is inserted in the tubular element 38 from above, and its distal end reaches a portion near the lower portion of the tubular element 38. The second base portion 28B is inserted in the sub-cup 24, and its distal end reaches a portion near the bottom wall 24B of the sub-cup 24.

A plurality of electrodes 30 are arranged on the surface of the first base portion 28A at set intervals in the longitudinal direction of the base 28, thus forming the liquid level detection sensor 26L. The highest position of the liquid level detection sensor 26L is higher than the full-tank level HL of the fuel tank 14. The first base portion 28A is inserted in the tubular element 38, so the tubular element 38 surrounds the liquid level detection sensor 26L.

A plurality of electrodes 30 are also arranged on the surface of the second base portion 28B at set intervals in the longitudinal direction of the base 28, thus forming a property detection sensor 26R. However, the property detection sensor 26R is shorter than the liquid level detection sensor 26L, and is formed at only the distal end portion of the second base portion 28B. The distal end of the second base portion 28B reaches a portion near the bottom wall 24B of the sub-cup 24.

The plurality of electrodes 30 that constitute the liquid level detection sensor 26L and the property detection sensor 26R have different capacitances between a portion that is in contact with fuel and a portion that is not in contact with fuel. In addition, the capacitance also varies depending on the property of fuel with which each electrode 30 is in contact. By using the difference in capacitance, it is possible to output a signal based on whether the contact range in which fuel is in contact with the capacitance sensor unit 26 is wide or narrow.

An output signal from the property detection sensor 26R and an output signal from the liquid level detection sensor 26L are transmitted to the sensor circuit unit 26C. Furthermore, information about a fuel property and a fuel level is transmitted to an engine control unit 70, and fuel injection, and the like, in the engine 20 are controlled.

Here, in a normal state, fuel is fed by the jet pump 48 into the sub-cup 24 such that the fuel liquid level in the sub-cup 24 reaches the upper end position of the sub-cup 24 (the inside of the sub-cup 24 is filled up). Therefore, the entire property detection sensor 26R is immersed in fuel. The property detection sensor 26R is able to detect the property of fuel inside the fuel tank 14 by utilizing the fact that the capacitance varies on the basis of the property of fuel with which the property detection sensor 26R is in contact.

In contrast to this, the liquid level detection sensor 26L is arranged in a vertical orientation inside the fuel tank 14. Therefore, the length of the portion immersed in fuel varies on the basis of the amount of fuel inside the fuel tank 14, and the capacitance also takes a different value. It is possible to detect the amount of fuel inside the fuel tank 14 by utilizing this phenomenon.

In the present embodiment, the property detection sensor 26R and the liquid level detection sensor 26L are formed on the single base 28. In other words, the property detection sensor 26R and the liquid level detection sensor 26L are integrated to constitute the capacitance sensor unit 26, so an increase in the number of components is suppressed.

As shown in FIG. 3, the bottom wall 24B of the sub-cup 24 has a fuel inflow hole 66. Furthermore, a one-way valve 68 is provided in the fuel inflow hole 66. The one-way valve 68 allows movement of fuel from the inside of the fuel tank 14 to the inside of the sub-cup 24, and blocks movement of fuel in the opposite direction. For example, when the fuel tank 14 is initially refueled (the fuel tank 14 is refueled in a state where there is no fuel inside the fuel tank 14 at all), fuel inside the fuel tank 14 flows into the sub-cup 24 from the fuel inflow hole 66, so the liquid level of fuel is equal between the fuel tank 14 and the sub-cup 24. In contrast to this, when the liquid level in the fuel tank 14 decreases, fuel inside the sub-cup 24 does not flow out into the fuel tank 14 through the fuel inflow hole 66. Fuel fed by driving the jet pump 48 is held inside the sub-cup 24, so the fuel liquid level is kept at the upper end position of the sub-cup 24.

Next, the operation of the fuel tank structure 12 according to the present embodiment will be described.

With this fuel tank structure 12, it is possible to feed fuel stored in the sub-cup 24 to the engine, or the like, through the fuel feed tube 44 by driving the fuel pump 40.

Even in a state where the amount of fuel inside the fuel tank 14 is small, fuel is present inside the sub-cup 24. Thus, even when fuel GS inclines and is unevenly distributed inside the fuel tank 14, the fuel GS inside the sub-cup 24 is held near the fuel suction port 42. Therefore, it is possible to inhibit a phenomenon (so-called shortage of fuel) that the fuel OS separates from the fuel filter 46 and, as a result, an oil film of the fuel filter 46 runs out. In addition, it is easy to keep a state where the fuel OS inside the sub-cup 24 is in contact with the property detection sensor 26R.

As the fuel pump 40 is driven, part of fuel is introduced into the jet pump 48 through the introduction tube 54. Thus, the jet pump 48 is driven, so the fuel GS is fed to the temporary containing portion 24T. Fuel overflowed from the temporary containing portion 24T flows beyond the partition wall 24P and is contained in the sub-cup 24 (region other than the temporary containing portion 24T).

Here, the case where the fuel tank 14 according to the present embodiment is refueled is assumed. Particularly, in the present embodiment, the case where the fuel tank 14 is refueled with a plurality of types of fuels having different specific gravities.

Hereinafter, high specific gravity fuel HF having a relatively high specific gravity and low specific gravity fuel LF having a relatively low specific gravity are distinguished from each other. An example of the low specific gravity fuel LF may be gasoline (fuel not mixed with ethanol, or the like), an example of the high specific gravity fuel HF may be ethanol fuel (fuel obtained by mixing ethanol with gasoline at a predetermined ratio, fuel formed of only ethanol, or the like).

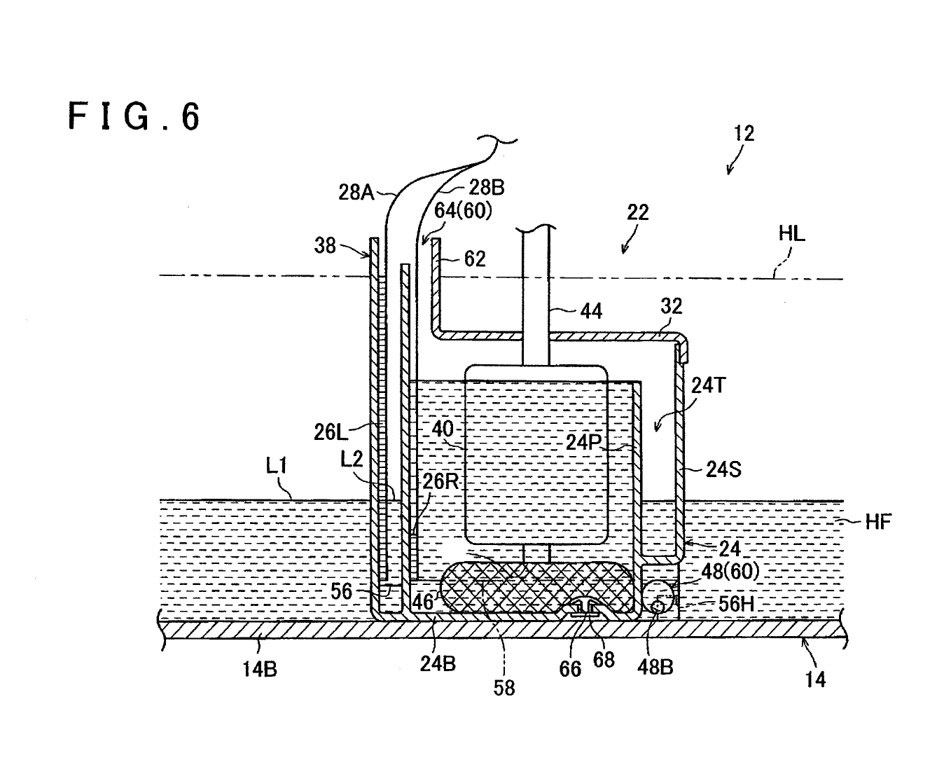

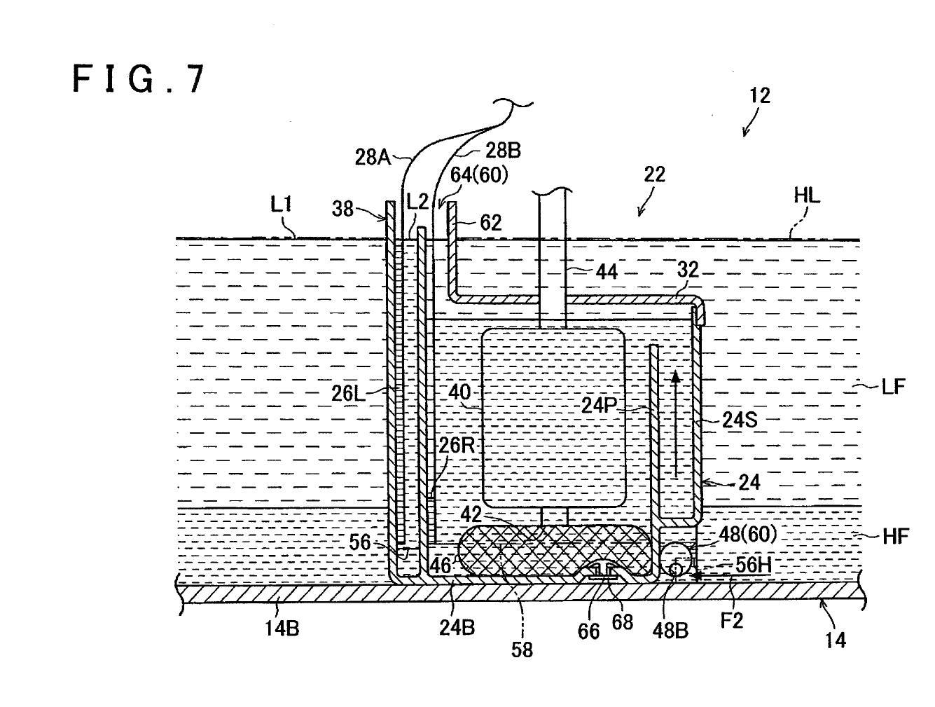

Initially, a state where the high specific gravity fuel HF is present in the fuel tank 14 (see FIG. 6) and a case where the fuel tank 14 is refueled with the low specific gravity fuel LF in this state (see FIG. 7) will be described.

When the engine 20 is driven before refueling, the fuel pump 40 is driven, and the jet pump 48 is driven by return fuel through the fuel supply tube 52. Therefore, the high specific gravity fuel HF inside the fuel tank 14 is introduced into the sub-cup 24.

Even when the fuel pump 40 and the jet pump 48 are stopped by stopping the engine 20 in this state, a liquid level L2 in the tubular element 38 coincides with a liquid level L1 in the fuel tank 14. In addition, the high specific gravity fuel HF is stored in the sub-cup 24 up to the upper end position of the partition wall 24P. Furthermore, the high specific gravity fuel HF is stored in the fuel storage member 58.

Here, when the fuel tank 14 is refueled with the low specific gravity fuel LF, the low specific gravity fuel LF is located above the high specific gravity fuel HF immediately after refueling and two layers are temporarily formed as shown in FIG. 7 (the high specific gravity fuel HF and the low specific gravity fuel LF are mixed with each other with time).

Part of the high specific gravity fuel HF flows into the fuel storage member 58 through the opening 56H as indicated by the arrow F2 in FIG. 4, so the high specific gravity fuel HF stored in the fuel storage member 58 moves into the tubular element 38 as indicated by the arrow F3. Inside the tubular element 38, the liquid level L2 of the high specific gravity fuel HF rises, and coincides with the liquid level L1 in the fuel tank 14. Particularly, a fuel storage volume of the fuel storage member 58 is larger than the volume of a portion of the inside of the tubular element 38, in which the liquid level detection sensor 26L is present. Thus, even when the low specific gravity fuel LF is fed up to the full-tank level HL, the low specific gravity fuel LF does not flow into the tubular element 38, and the high specific gravity fuel HF contacts all the range of the liquid level detection sensor 26L.

In addition, the state where the high specific gravity fuel HF is stored in the sub-cup 24 is kept, so the high specific gravity fuel HF is in contact with the property detection sensor 26R.

That is, with the fuel tank structure 12 according to the present embodiment, even when the low specific gravity fuel LF is fed into the fuel tank 14 in which the high specific gravity fuel HF remains, a fuel of the same type (high specific gravity fuel HF) is in contact with both the liquid level detection sensor 26L and the property detection sensor 26R immediately after refueling. Particularly, the entire property detection sensor 26R is immersed in the high specific gravity fuel HF. In addition, the high specific gravity fuel. HF is in contact with part or the entire liquid level detection sensor 26L on the basis of the liquid level L2 in the tubular element 38; however, a state where the low specific gravity fuel LF is not in contact with the liquid level detection sensor 26L is achieved.

In order to actually detect the liquid level in the fuel tank 14, initially, the property of fuel is detected by the property detection sensor 26R. That is, the property detection sensor 26R takes a different capacitance on the basis of the type of fuel with which the property detection sensor 26R is in contact, so it is possible to determine whether the contact fuel is the low specific gravity fuel LF or the high specific gravity fuel HF using the capacitance (in the case of the present embodiment, it is possible to determine that the type of fuel is the high specific gravity fuel HF).

Subsequently, the capacitance of the liquid level detection sensor 26L is measured. That is, the capacitance of the liquid level detection sensor 26L varies on the basis of the contact range in which fuel is in contact with the liquid level detection sensor 26L, so it is possible to acquire the liquid level L2 in the tubular element 38 and further acquire the liquid level L1 in the fuel tank 14 from the capacitance.

In the present embodiment, as described above, even when the low specific gravity fuel LF is fed into the fuel tank 14 in which the high specific gravity fuel HF remains, the high specific gravity fuel HF that is a fuel of the same type as the fuel that is in contact with the property detection sensor 26R is in contact with the liquid level detection sensor 26L, and contact of the low specific gravity fuel LF is inhibited. The capacitance detected by the property detection sensor 26R is used as a reference, and the liquid level is obtained from the capacitance detected by the liquid level detection sensor 26L. Thus, it is possible to further accurately detect the liquid level. Therefore, further accurate liquid level detection is possible. This point will be described below in more detail.

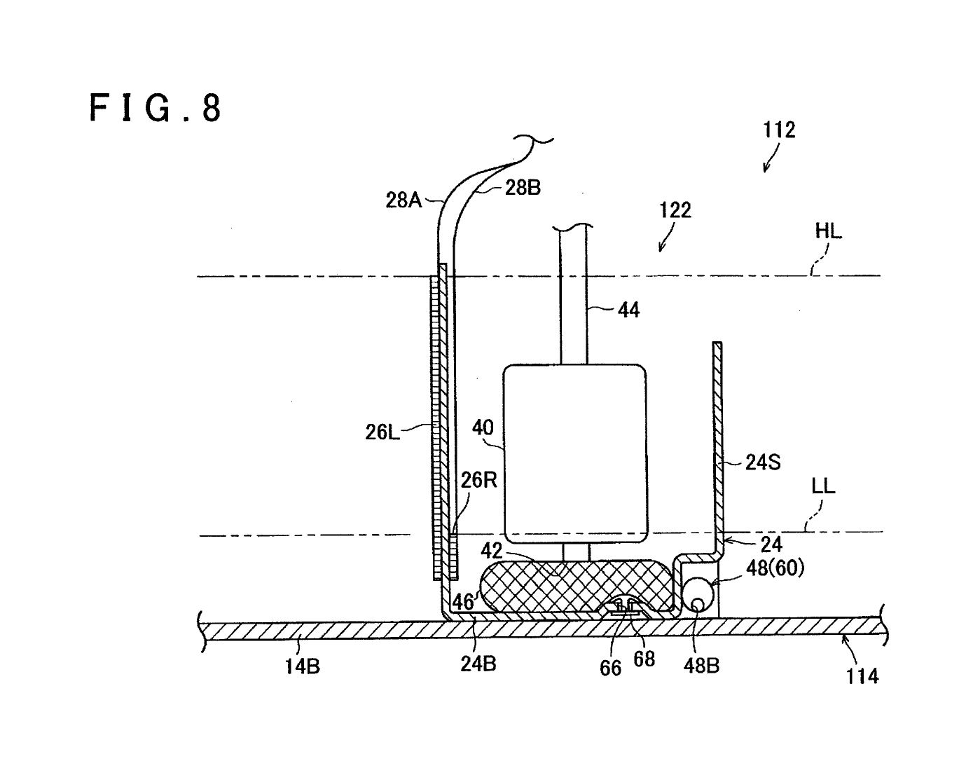

FIG. 8 shows a fuel pump module 122 of a fuel tank structure 112 according to a comparative embodiment. In the comparative embodiment, the tubular element 38 and the fuel storage member 58 according to the first embodiment are not provided, and the partition wall 24P is also not formed inside the sub-cup 24. The liquid level detection sensor 26L is arranged on the outer side of the peripheral wall 24S of the sub-cup 24.

Thus, when the low specific gravity fuel LF is fed into the fuel tank 114 according to the comparative embodiment in a state where the high specific gravity fuel HF remains, because the high specific gravity fuel HF is located at a relatively low side, the specific gravity of fuel that is in contact with the liquid level detection sensor 26L gradually becomes lower from a lower part of the contact portion toward an upper part thereof.

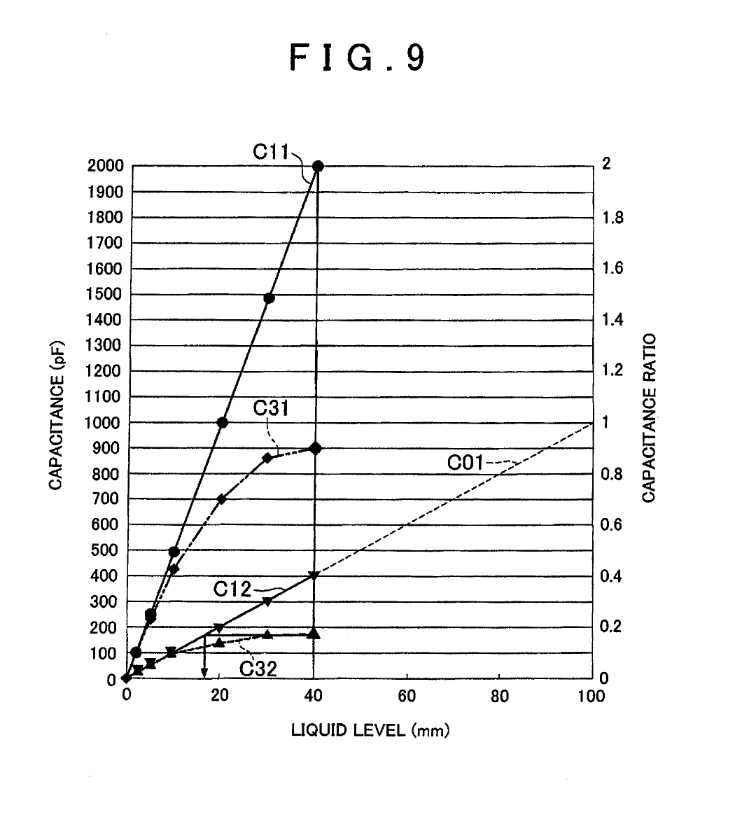

FIG. 9 shows an example of a capacitance of the liquid level detection sensor 26L and a value (capacitance ratio) obtained by dividing the capacitance of the liquid level detection sensor 26L by a capacitance of the property detection sensor 26R in the case of each of the present embodiment and the comparative embodiment.

In this example, both in the present embodiment and in the comparative embodiment, an actual liquid level in the fuel tank is 40 mm for the sake of convenience of description. In addition, the capacitance of the property detection sensor 26R with which the high specific gravity fuel HF is in contact is a constant value (5000 pF).

When a uniform fuel (in the example of the graph, the high specific gravity fuel HF) is in contact with the liquid level detection sensor 26L as in the case of the first embodiment, the capacitance of the liquid level detection sensor 26L is directly proportional to the liquid level L2 (contact area of the fuel GS) as indicated by the continuous line C11. Because the capacitance of the property detection sensor 26R is a constant value, the capacitance ratio is directly proportional to the liquid level L2 as indicated by the solid line C12 in FIG. 9, and is on a target value indicated by the dashed line C01.

Generally, where the area of each of two electrodes is S, the distance between the electrodes is d and the dielectric constant is ∈, the capacitance C is expressed by C=∈×(S/d). The capacitance ratio is (C_{26L}/C_{26R}) where the capacitance of the liquid level detection sensor 26L is C_{26L} and the capacitance of the property detection sensor 26R is C_{26R}.

Particularly, in the graph shown in FIG. 9, the area S of each electrode and the distance d between the electrodes in the liquid level detection sensor 26L and the property detection sensor 26R are adjusted such that the capacitance ratio becomes 1 in a state where the liquid level detection sensor 26L is immersed in fuel up to the upper end of the liquid level detection sensor 26L (liquid level=100 mm).

When the liquid level is 40 mm, the capacitance of the liquid level detection sensor 26L is 2000 pF, so the capacitance ratio is 2000 pF/5000 pF=0.4. Because the capacitance ratio where the liquid level is 100 mm is set to 1, an actual liquid level is calculated as 100 mm×0.4=40 mm. That is, in the present embodiment, because the capacitance ratio (C_{26L}/C_{26R}) is directly proportional to the liquid level, it is possible to easily and accurately acquire the liquid level L2.

In contrast to this, with the fuel tank structure 112 according to the comparative embodiment, when the liquid level rises through feeding of the low specific gravity fuel LF, both the high specific gravity fuel HF and the low specific gravity fuel LF contact the liquid level detection sensor 26L, so the capacitance of the liquid level detection sensor 26L is not directly proportional to the liquid level in the fuel tank, and takes a value smaller than the continuous line C11 with a rise in liquid level as indicated by the alternate long and two-short dashes line. In the comparative embodiment, the capacitance ratio also becomes smaller than an actual value as indicated by the dashed line C32. For example, when the liquid level is 40 mm, the capacitance of the liquid level detection sensor 26L according to the comparative embodiment is 900 pF. When the liquid level in the fuel tank 114 is calculated using the above-described mathematical expression (1) using this capacitance, the liquid level is 18 mm, so the liquid level is calculated to be lower by 22 mm than the actual liquid level.

In this way, in the present embodiment, it appears that occurrence of an error in the liquid level obtained on the basis of the capacitance of the liquid level detection sensor 26L as in the case of the comparative embodiment is suppressed.

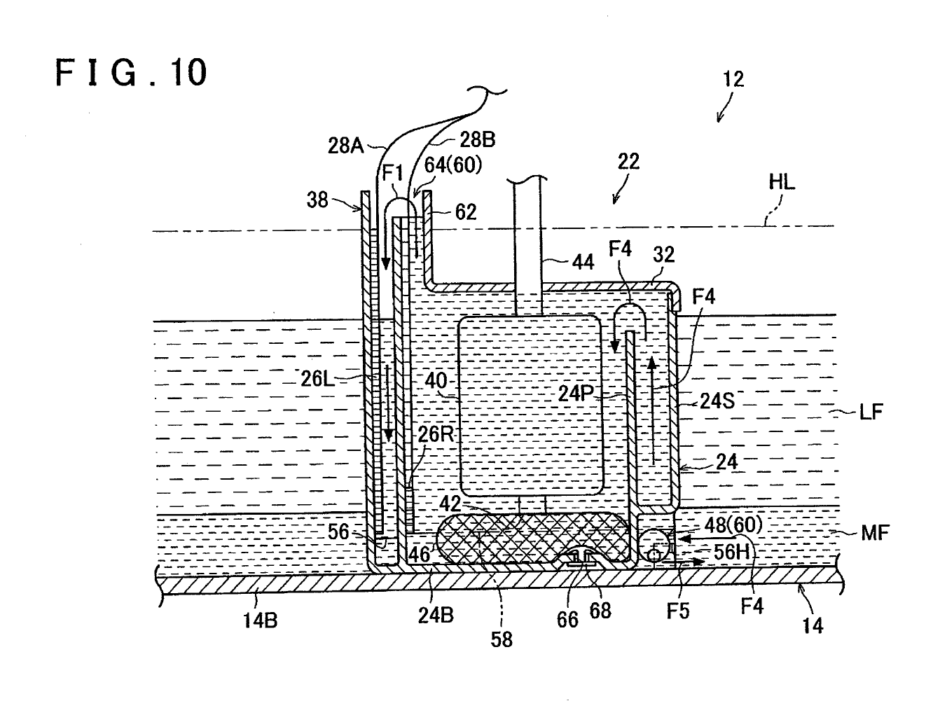

As a predetermined period of time elapses after refueling, the high specific gravity fuel HF and the low specific gravity fuel LF mix with each other. Hereinafter, the mixed fuel is termed composite fuel MF. In the example shown in FIG. 10, the fed low specific gravity fuel LF mixes with the high specific gravity fuel HF present in the fuel tank 14, and the composite fuel MF is present at the lower portion in the fuel tank 14.

As the fuel pump 40 and the jet pump 48 are driven by driving the engine 20, the composite fuel MF inside the fuel tank 14 is fed by the jet pump 48 into the sub-cup 24 as indicated by the arrow F4. In this way, the composite fuel MF of which the property is uniformed contacts the property detection sensor 26R, so the detection accuracy of the property detection sensor 26R for the property of fuel is high.

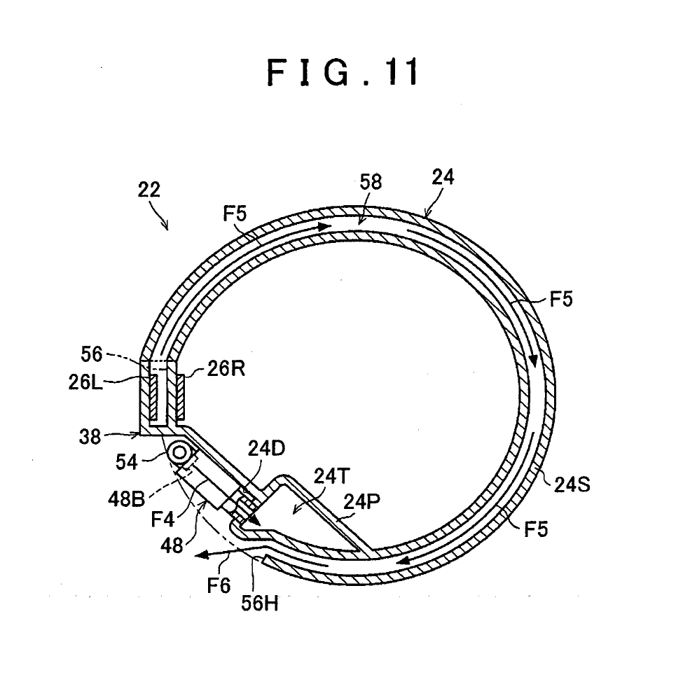

Furthermore, when the jet pump 48 is driven, the composite fuel MF flows beyond the partition wall 24P, passes through the fuel introduction passage 64 from the inside of the sub-cup 24 and flows into the tubular element 38 from above as indicated by the arrow F1. Fuel in the tubular element 38 is replaced with the composite fuel MF of which the property is uniformed, and the composite fuel MF contacts the liquid level detection sensor 26L. Fuel having the same mixture ratio contacts the upper portion and lower portion of the liquid level detection sensor 26L, so the detection accuracy for the liquid level also increases. Fuel inside the tubular element 38 flows through the inside of the fuel storage member 58 toward the opening 56H as indicated by the arrow F5 in FIG. 11, and is returned to the inside of the fuel tank 14 through the opening 56H as indicated by the arrow F6.

In this case as well, the same fuel contacts the property detection sensor 26R and the liquid level detection sensor 26L, so the fuel property detected by the property detection sensor 26R may be used as a reference for detecting the liquid level with the use of the liquid level detection sensor 26L. That is, with the use of the single property detection sensor 26R, it is possible to not only simply detect the property of fuel but also determine the reference in liquid level detection.

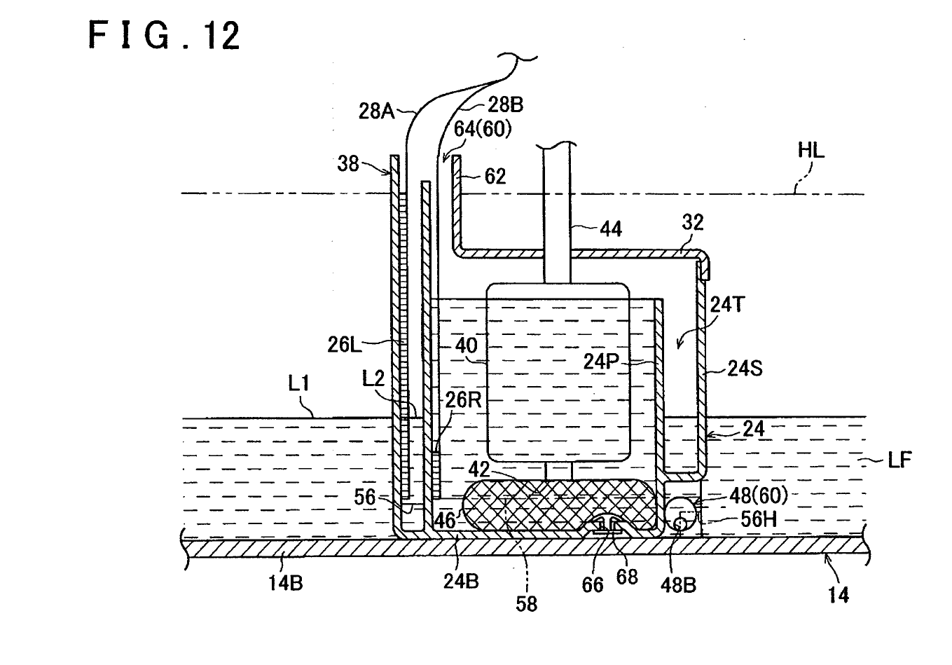

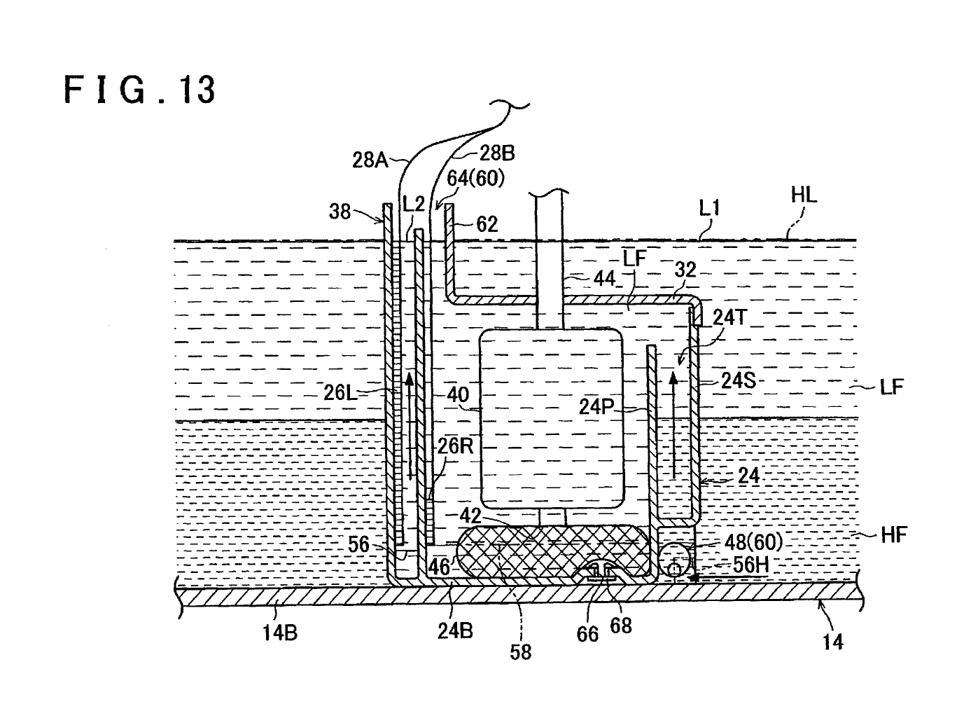

In the above description, the case where the low specific gravity fuel LF is fed into the fuel tank 14 in which the high specific gravity fuel HF remains is illustrated. Hereinafter, on the other hand, the case (see FIG. 13) in which the high specific gravity fuel HF is fed into the fuel tank 14 in which the low specific gravity fuel LF remains (see FIG. 12) will be described.

In this case, when the engine 20 is driven before refueling, the fuel pump 40 and the jet pump 48 are driven, so the low specific gravity fuel LF inside the fuel tank 14 is introduced into the sub-cup 24.

Even when the fuel pump 40 and the jet pump 48 are stopped by stopping the engine 20, the liquid level L2 in the tubular element 38 coincides with the liquid level L1 in the fuel tank 14. In addition, inside the sub-cup 24, the low specific gravity fuel LF is stored up to the upper end position of the partition wall 24P. The low specific gravity fuel LF is stored in the fuel storage member 58.

Here, when the high specific gravity fuel HF is fed into the fuel tank 14, the high specific gravity fuel HF is located below the low specific gravity fuel LF and two layers are temporarily formed as shown in FIG. 13 (the high specific gravity fuel HF and the low specific gravity fuel LF mix with each other with time).

Part of the high specific gravity fuel HF flows into the fuel storage member 58 through the opening 56H, so the low specific gravity fuel LF stored in the fuel storage member 58 moves into the tubular element 38. Thus, inside the tubular element 38, the liquid level L2 of the low specific gravity fuel LF rises, and coincides with the liquid level L1 in the fuel tank 14. Even when the high specific gravity fuel HF is fed up to the full-tank level HL, the high specific gravity fuel HF does not flow into the tubular element 38, and the low specific gravity fuel LF contacts all the range of the liquid level detection sensor 26L.

Because the state where the low specific gravity fuel LF is stored in the sub-cup 24 is kept, the low specific gravity fuel LF is in contact with the property detection sensor 26R.

That is, with the fuel tank structure 12 according to the present embodiment, even when the high specific gravity fuel HF is fed into the fuel tank 14 in which the low specific gravity fuel LF remains, a fuel of the same type (low specific gravity fuel LF) is in contact with both the liquid level detection sensor 26L and the property detection sensor 26R immediately after refueling. In addition, the low specific gravity fuel LF is in contact with part of or the entire liquid level detection sensor 26L on the basis of the liquid level L2; however, a state where the high specific gravity fuel HF is not in contact with the liquid level detection sensor 26L is achieved. Therefore, further accurate liquid level detection is possible.

Particularly, when the high specific gravity fuel HF is fed into the fuel tank 14 in which the low specific gravity fuel LF remains, the high specific gravity fuel HF is located at a relatively low layer, so, with a structure having no fuel storage member 58 (for example, sec the structure shown in FIG. 8 as the comparative embodiment), there is a high possibility that the high specific gravity fuel HF contacts the liquid level detection sensor 26L. However, in the present embodiment, it is possible to inhibit contact of the fed high specific gravity fuel HF with the liquid level detection sensor 26L. That is, when the high specific gravity fuel HF is fed into the fuel tank 14 in which the low specific gravity fuel LF remains, the invention significantly contributes in the viewpoint of further accurate liquid level detection.

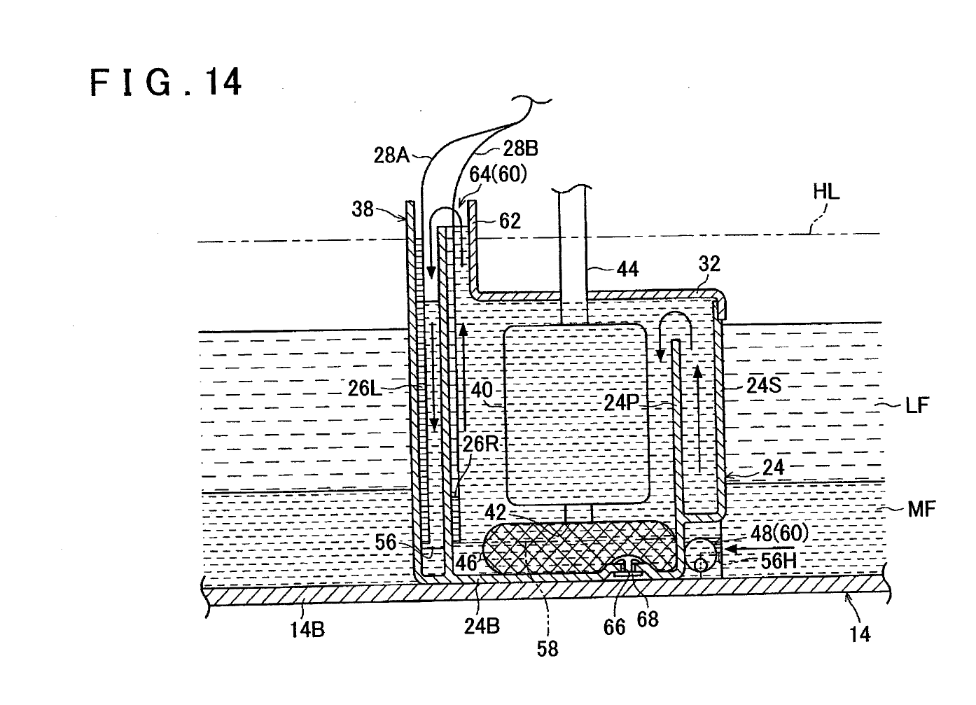

After refueling (after a lapse of a predetermined period of time), as shown in FIG. 14, the high specific gravity fuel HF and the low specific gravity fuel LF mix with each other, and become composite fuel MF. As the fuel pump 40 and the jet pump 48 are driven by driving the engine 20, the composite fuel MF inside the fuel tank 14 is fed by the jet pump 48 into the sub-cup 24. The composite fuel MF of which the property is uniformed contacts the property detection sensor 26R, so the detection accuracy of the property detection sensor 26R for the property of fuel is high.

Furthermore, when the jet pump 48 is driven, the composite fuel MF flows beyond the partition wall 24P, passes through the fuel introduction passage 64 from the inside of the sub-cup 24 and flows into the tubular element 38 from above. Fuel inside the tubular element 38 is replaced with the composite fuel MF of which the property is uniformed, and the composite fuel MF contacts the liquid level detection sensor 26L. Fuel having the same mixture ratio contacts the upper portion and lower portion of the liquid level detection sensor 26L, so the detection accuracy for the liquid level also increases.

In this case as well, the same fuel contacts the property detection sensor 26R and the liquid level detection sensor 26L, so the fuel property detected by the property detection sensor 26R may be used as a reference for detecting the liquid level with the use of the liquid level detection sensor 26L. That is, with the use of the single property detection sensor 26R, it is possible to not only simply detect the property of fuel but also determine the reference in liquid level detection.

In the first embodiment, the location of the property detection sensor 26R is not limited to the inside of the sub-cup 24; however, when the property detection sensor 26R is arranged inside the sub-cup 24, it is possible to detect the property of fuel that is fed to the engine 20 by driving the fuel pump 40. Instead, the property detection sensor 26R may be arranged at the lower portion inside the tubular element 38. With this arrangement, it is possible to detect the property of fuel near the liquid level detection sensor 26L.

Next, a second embodiment of the invention will be described. The second embodiment differs from the first embodiment in the structure of a capacitance sensor unit 76; however, the overall configuration of a fuel tank structure according to the second embodiment is the same as that of the first embodiment, so the fuel tank structure according to the second embodiment is not shown separately.

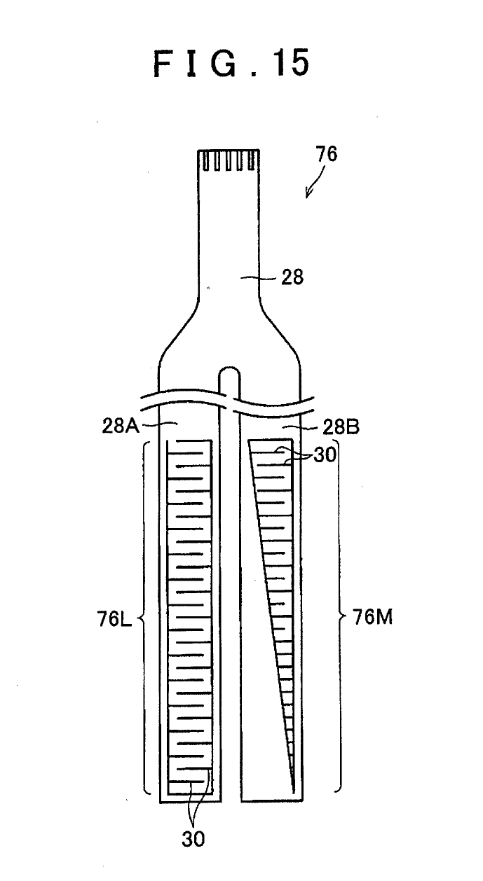

FIG. 15 shows the capacitance sensor unit 76 for the fuel tank structure according to the second embodiment. The capacitance sensor unit 76 includes the base 28, and a liquid level detection sensor 76L substantially similar to that of the first embodiment is provided at the first base portion 28A. A liquid level detection sensor 76M, instead of the property detection sensor 26R according to the first embodiment, is provided at the second base portion 28B.

The liquid level detection sensor 76M has substantially the same height as the liquid level detection sensor 26L. The upper end portion of the liquid level detection sensor 76M has substantially the same or larger width than that of the liquid level detection sensor 26L; however, the width gradually reduces downward, and has an inverted triangular shape as a whole.

In the liquid level detection sensor 76L, the capacitance and the liquid level are directly proportional to each other, and there is no difference in sensitivity due to the liquid level. In contrast to this, in the liquid level detection sensor 76M, the sensitivity is lower at a low liquid level (when the remaining level of fuel GS is low).

Even when the property of fuel GS changes, the capacitance ratio (76M/76L) becomes a value close to a target value (dashed line C01) when compared with the capacitance ratio (see the dashed line C32 in FIG. 9) according to the comparative embodiment. In the second embodiment, the capacitance ratio (76M/76L) is referenced, so it is possible to detect an accurate liquid level.

In the second embodiment as well, when fuel of a type different from fuel remaining in the fuel tank 14 is fed into the fuel tank 14, fuel stored in the fuel storage member 58 moves to the tubular element 38. Thus, fuel of the same type contacts all the range of the liquid level detection sensor 26L. Therefore, the accuracy of liquid level detection increases.

In the second embodiment, the liquid level detection sensor 76M may be arranged inside the sub-cup 24 or may be arranged inside the tubular element 38.

In each of the above-described embodiments, the description is made on the example in which the fuel storage volume of the fuel storage member 58 is larger than the internal volume of the portion of the inside of the tubular element 38, in which the liquid level detection sensor 26L is present. Thus, even when all the fuel stored in the fuel storage member 58 moves into the tubular element 38, it is possible to keep the state where fuel of the same type reliably contacts all the range of the liquid level detection sensor 26L.

The structure (shape) of the fuel storage member 58 is not limited to an annular shape in which the sub-cup 24 is surrounded as described above. For example, the structure (shape) of the fuel storage member 58 may extend radially outward in a cylindrical shape when the sub-cup 24 is viewed in plan. When the fuel storage member 58 is formed in an annular shape in which the sub-cup 24 is surrounded, a projection at the time when the sub-cup 24 is viewed in plan reduces, and the sub-cup 24 and the fuel storage member 58 are easily mounted inside the fuel tank 14.

The description is made on the example in which the sub-cup 24 is provided; however, a structure with no sub-cup 24 is applicable. In this case, the property detection sensor 26R according to the first embodiment and the liquid level detection sensor 76M according to the second embodiment may be arranged inside the tubular element 38 as described above.

Furthermore, a structure with no property detection sensor 26R in the first embodiment or a structure with no liquid level detection sensor 76M in the second embodiment is applicable. That is, when fuel of a type different from the type of fuel remaining in the fuel tank 14 is fed into the fuel tank 14, fuel stored in the fuel storage member 58 moves to the tubular element 38, so the fuel of the same type contacts all the range of the liquid level detection sensor 26L, and the accuracy of liquid level detection increases.

In each of the above-described embodiments, a structure with no fuel introduction device 60 is applicable. That is, when the engine 20 is driven, even with a structure that fuel is not introduced from the upper portion of the tubular element 38, it is advantageous in improving the accuracy of liquid level detection after a different-type fuel is fed. In the case where the fuel introduction device 60 is provided, when the engine 20 is driven (when the jet pump 48 is driven), it is possible to introduce the composite fuel into the tubular element 38, so further accurate liquid level detection is possible. The fuel introduction device 60 includes the fuel introduction passage 64 and the jet pump 48; however, in order to introduce fuel into the tubular element 38, a structure with the jet pump 48 is desirable. Thus, only by additionally providing the fuel introduction passage 64, the fuel introduction device 60 may be formed. In addition, when a structure with no fuel introduction passage 64 is provided, it is possible to eventually achieve a structure with no fuel introduction device 60.

In the structure with no fuel introduction passage 64, by also omitting the sub-cup lid 32 (or providing a fuel outflow hole), fuel overflowed from the sub-cup 24 just needs to be returned into the fuel tank 14.

The liquid level detection sensor 26L and the property detection sensor 26R each are a sensor having such a structure that the capacitance varies on the basis of the length of the contact portion of fuel or the property of fuel as described above; however, a sensor having such a structure that outputs a variation in amount other than capacitance as a signal is also applicable. For example, a sensor of a type that an electric resistance varies on the basis of the length of the contact portion of fuel or the property of fuel is also applicable.

1. A fuel tank structure comprising:
a fuel tank configured to contain fuel inside;
a liquid level detection sensor arranged in a vertical orientation inside the fuel tank and configured such that a capacitance of the liquid level detection sensor varies on the basis of a contact range in which the fuel is in contact with the liquid level detection sensor;
a tubular element extending vertically while laterally surrounding the liquid level detection sensor and configured to allow the fuel to enter from a lower portion of the tubular element to an inside of the tubular element and to exit from the inside to the lower portion; and
a fuel storage member that communicates with the inside of the tubular element and the inside of the fuel tank through a fuel input/output port and configured to store the fuel inside the fuel tank.

2. The fuel tank structure according to claim 1, wherein
a fuel storage volume of the fuel storage member is larger than an internal volume of a portion of the inside of the tubular element, in which the liquid level detection sensor is present.

3. The fuel tank structure according to claim 1, further comprising:
a property detection sensor arranged inside the fuel tank and configured such that a capacitance of the property detection sensor varies on the basis of a property of the fuel.

4. The fuel tank structure according to claim 3, further comprising:
a sub-cup provided inside the fuel tank and configured to contain the fuel inside the fuel tank, the property detection sensor being provided inside the sub-cup.

5. The fuel tank structure according to claim 4, further comprising:
a fuel introduction device configured to introduce the fuel inside the sub-cup into the tubular element.

6. The fuel tank structure according to claim 5, wherein
the fuel introduction device includes a communication portion that communicates an upper portion of the sub-cup with an upper portion of the tubular element and a pressure pump configured to feed the fuel inside the fuel tank into the sub-cup under pressure.

7. The fuel tank structure according to claim 4, wherein the fuel storage member extends along a periphery of the sub-cup.
